(19) United States
(12) Patent Application Publication
(10) Pub. No.: US 2006/0259368 A1
(43) Pub. Date: Nov. 16, 2006

(54) Stored seller contact information marketing

(76) Inventors: John Patrick McCarthy, Wilmette, IL (US); Michael Edward McCarthy, Wilmette, IL (US)

Correspondence Address: JENNER & BLOCK, LLP, ONE IBM PLAZA, CHICAGO, IL, 60611, US

(21) Appl. No.: 11/127,169

(22) Filed: May 12, 2005

(51) Int. Cl. G06Q 30/00

(52) U.S. Cl. 705/26

(57) ABSTRACT

This marketing method has a seller or party affiliated with the seller motivate at least one consumer or at least one other business (seller, company) to store or allow someone else to store the seller's contact information into a possession of theirs. The motivation for the consumer or other sellers for having the seller's contact information stored into a possession(s) of theirs would typically be some form of compensation such as money, but could be other things. Typically when the consumer stores the seller's contact information it will become readily available to him/her for extended periods of time and in many places increasing the likelihood that he/she will do business with the seller because of the ease at which the seller's contact information would be obtained.

### FIELD OF INVENTION

This method involves marketing specifically marketing, which attempts to get a consumer to contact a seller of a product or service.

### BACKGROUND OF THE INVENTION

A large amount of marketing attempts to sell products or services to consumers through making seller's (companies, businesses) contact information readily available to consumers who may or may not already desire the product or service being marketed. Usually sellers (companies, businesses) make their contact information readily available during times and in places where they believe a lot of consumers are interested in buying their product or service. For example, food delivery ads are usually placed on advertising mediums during times when a large amount of people are hungry and in places where they are likely to order food. To get consumers to contact them, food delivery ads often provide easily available contact information like their phone number, for the consumer to call. For a seller to provide contact information to consumers for extended periods of time and/or in multiple locations is often very costly resulting in higher marketing costs or a loss of sales because consumers who desired the product or service the seller provides could not remember the seller's contact information so didn't do business

Currently sellers sell products containing their own contact information for consumers to call in case they have a question or complaint about the product they bought. This marketing method only makes it convenient for consumers to contact the seller they bought the product from and the consumer will usually get rid of the seller's contact information because it is a hassle to keep saved and usually at the time they receive it they don't believe they will need it since they don't believe they will need to contact the seller. Also, sellers sell products together with complimentary products included in them and occasionally these products also contain those companies contact information, but consumers dispose of this contact information for the same reasons. Business cards, postcards, and flyers are also used by sellers to attempt to sell products or services to people, but for similar reasons they are frequently not saved by the people they are given to, and rarely are they saved by consumers.

Overall, it currently requires large amounts of effort and money for sellers to provide consumers with their contact information for extended periods of time and/or in a large area.

### OBJECTS AND ADVANTAGES

This marketing method is able to create a permanent marketing medium and may even solve many of the advertising problems that sellers have providing contact information to consumers. This method of marketing is able to provide the seller using it with cheap and effective marketing for long periods of time and in multiple locations. Compared to most other marketing methods attempting to accomplish similar results this method is cheap, if not free to implement and requires very little if any effort and money to maintain. It is an object of this invention to provide a method for motivating consumers to store contact information into an electronic device preferably an electronic communication device belonging to the consumer such as a cell phone or a Blackberry®. It is also an object of this invention to provide a method for providing products to consumers containing at least one seller's contact information.

### SUMMARY

This marketing method has a seller of a product or service or party affiliated with the seller motivate at least one consumer or at least one other business (seller, company) to store or allow someone else to store the seller's contact information into a possession of theirs: typically a cell phone or any other electronic communication device. The preferred motivation is compensation. Having the seller's contact information will typically make it convenient for the consumer to recall the seller's contact information making him/her more likely to contact the seller and buy a product or service from them.

### DESCRIPTION

This Method of marketing has two main preferred embodiments. The first main preferred embodiment is having a seller or a party affiliated with the seller motivate usually through compensating at least one consumer or other seller to store or allow someone else to store the seller's contact information into at least one possession of theirs. Preferably the seller would motivate the consumer through offering compensation for storing or having their contact information stored. The consumer could be compensated on a one-time basis, an order amount basis, a time basis or in a variety of different ways.

The preferable place of storage would be in an item with cellular capabilities, typically an electronic communication device. We will refer to “electronic communication device” as the description for any device that enables voice, data, or e-mail to be transmitted. An electronic communication device is preferable because through it the consumer can contact the seller directly from the place of storage. The seller may require consumers to store the contact information in a certain place or in a certain way. For example, the sellers or party affiliated with the sellers may require consumers to store the seller's contact information in a cell phone under the name of the seller, under the name of a certain product or service the seller sells or under any other name any party involved chooses and stored under the “contacts” or “references” or “addresses” section in the consumer's cell phone. Once the contact information is stored into the consumer's possession it will likely become readily available to the consumer for extended periods of time and typically in multiple locations increasing the likelihood the consumer will do business with the seller. The seller's goal in this form of marketing is to have multiple consumers with their contact information stored, which will likely give the seller many repeat customers.

The sellers using this marketing method could inform consumers about it and encourage them to participate by communicating through many different advertising methods including commercials on TV, ads on the radio, print, and orally through an employee of the business.

In the case if the seller using this method has multiple locations with different types of contact information the consumer would preferably be motivated to store the contact information for the seller's location closest to him or her, but the consumer could be motivated to store the contact information for other locations or the contact information for multiple locations as well.

In the case if consumers are compensated for having the seller's contact information stored, the seller or party affiliated with the seller may decide to check to confirm that the consumer does have the seller's contact information stored before providing compensation to the consumer. The seller may assume the consumer has the contact information stored and provide compensation without checking if the consumer has the contact information stored.

The second main preferred embodiment of this marketing method is where a third party would get at least one, preferably at least five, more preferably at least ten and most preferably at least twenty sellers to pay or compensate another business (seller, company) to store their contact information (preferably cell phone number or e-mail address) into the products they sell. The third party in this method could pay or compensate the business selling the products containing the seller's contact information. Or the sellers who are having their contact information stored into the products that the other business is selling, could compensate that business. The preferable type of product being sold or provided containing the seller's contact information would be an electronic communication device such as a cell phone. The business selling products containing the seller's contact information could sell the products to another business or to consumers. The third party in this process would typically receive a determined amount of compensation for connecting the businesses.

This marketing method could also work without the third party connecting the two sellers and instead the two sellers could contact each other directly and the seller or sellers could compensate the other business directly for selling products containing their contact information.

The contact information could be stored in a certain way or in certain places in the product for example in a cell phone or other electronic communication device, it could be stored under the name of the company, under the name of a type of product or service the company sells, or under any other name any party involved in the process chooses and under “contacts” in the cell phone. An example would be as follows: A cell phone or electronic communication type device would be purchased by a consumer with phone numbers and/or or e-mail addresses pre-programmed onto the device. A consumer would find under “contacts” or “addresses” the word: Pizza or, (for instance), Dominos®, or Papa Johns® with corresponding contact information for the sellers. By simply e-mailing an order, or phoning the number, the consumer can easily order a pizza or other product from the pizza provider. The cell phone seller or service provider would receive compensation from the sellers whose number or e-mail address is pre-programmed. The cell phone seller or service provider can keep the compensation or pass some or all or some of it along to the purchaser of the device with the pre-programmed information on it.

In the case of a seller with multiple locations, preferably the contact information for the closest location to where the product is being sold or provided would be pre-programmed in the product.

Eventually, the products containing the seller's contact information would be sold or given to consumers. The end result of this marketing method is similar to the first main embodiment except in this one the contact information will come pre-stored into products the consumer buys so the consumer doesn't necessarily have to agree to having the seller's contact information stored into the product he or she is buying. However the business selling the products to consumers may ask the consumer if he or she will allow the seller's contact information to be stored into the product(s) he or she is buying. It is likely that the consumer will be motivated to buy a product with contact information pre-programmed through possibly being offered compensation.

Even though in both of the embodiments the consumer may be able to remove the contact information from the item that it is stored in, not all would have the seller's contact information removed resulting with many consumers who kept the seller's contact information stored giving the sellers many consumers who have their contact information stored.

In both of these embodiments having the seller's contact information stored would be very little additional hassle for the consumer because it will be stored in something they use and have around them anyway like a cell phone or other electronic communication device, which decreases the likelihood they will get rid of the seller's contact information.

An example of the first main embodiment of this marketing method in use would be a pizza place advertising over the radio, television or in person through its employees, telling consumers that if they store their pizza place's phone number into their phone in the “contacts” section or in the “address” section under the name “pizza” or under the pizza place's name, they will receive a discounted price on all of the purchases they make as long as they have the number stored. The pizza place could also provide extra compensation for storing the pizza place's number under the name of the type of product they provide such as “pizza” instead of storing it under the pizza places name. The consumers would then store the pizza place's number in their phone and from then on whenever they wanted pizza and had their phone around them they would be more likely to call the pizza place with the phone number stored to order pizza because it's contact information would be so easily obtained and because they would be getting a discount off their purchase. Before compensating consumers with a discount off their purchase, the pizza place would have an employee check to validate that the customer had their phone number stored into their cell phone under the name “pizza” or the name of the company through having an employee ask the consumers to see that the seller's contact information is stored into their possession.

An example of the other main embodiment of this marketing method is if a third party got 10 sellers of products and services including a plumbing service, a drugstore and a bookstore to pay a cell phone seller to program their companies' phone number into the cell phones they sell under “contacts” or “addresses” and under the name of the service or product they provide or the name of the company. For example Walgreen's® pharmacy could be stored under the name “Walgreen®” or “pharmacy” or “Walgreen's® Pharmacy”. In the case if the seller has multiple locations the contact information for the closest location could be stored in the product the other business is selling or providing. When consumers buy the cell phones they will have the seller's contact information stored under “contacts” making it is instantly available to them whenever they have their cell phone around them. If the buyer of the phone later needed a plumber he or she would be far more likely to call the plumbing service with the number stored under “contacts” in his or her phone.

Some ways the seller or party affiliated with the seller could motivate or compensate consumers and/or other businesses to store or allow someone else to store the seller's contact information into a possession of theirs could be through: giving them a special deal, giving them money off their purchase, giving them a free product or service, giving them a percentage off their purchase, giving them money, giving them coupons for future purchases, entering them into a drawing to win something, giving them a quicker delivery time on their product or service, telling them why they should store the sellers contact information such as the benefits of doing so, asking them to, giving them future benefits, allowing them to do business with the seller, or a combination of any of the ways listed.

Although the preferable place for the contact information to be stored is a phone or cell phone, this marketing method could include the seller's contact information being stored into any electronical device belonging to at least one consumer, or written on anything belonging to a consumer. The place of storage is preferably an electronic communication device with memory.

Also, although the preferred contact information is the seller's phone number, the consumer or other seller could be required to store such information as website address or street address.

I claim:

1. A method consisting of a seller or party affiliated with said seller providing compensation to at least one consumer for storing or allowing said seller or said party affiliated with said seller to store said seller's contact information into at least one of said consumer's possessions.

2. The method of claim 1 wherein said compensation is money.

3. The method of claim 1 wherein said compensation is an item.

4. The method of claim 1 wherein said contact information is said seller's phone number.

5. The method of claim 1 further including said contact information being stored under the name of at least one product or service said sellers provides.

6. The method of claim 1 further including said contact information being stored under the name of said seller.

7. The method of claim 1 wherein said possession is a phone.

8. The method of claim 1 wherein said possession is an electronic device.

9. The method of claim 1 further including said consumer being compensated for storing said seller's contact information once.

10. The method of claim 1 further including said consumer being compensated for storing multiple types of said seller's contact information.

11. The method of claim 1 further including said consumer being compensated for keeping said contact information stored.

12. A business method consisting of a seller or party affiliated with said seller providing compensation to at least one other business for selling or providing products containing said seller's contact information in said products.

13. The method of claim 21 wherein said product is any electronic device.

14. The method of claim 21 wherein said product is a cell phone.

15. The method of claim 21 wherein said contact information is said seller's phone number.

16. The method of claim 21 further including said business selling said products to another business.

17. The method of claim 21 further including said business selling product to consumers.

18. The method of claim 21 further including consumer who buys said business's products being motivated to keep said seller's contact information stored.

19. The method of claim 21 further including at least 5 said sellers compensating said business.

20. The method of claim 21 further including at least 10 said sellers compensating said business.

21. A business method consisting of a seller or party affiliated with said seller advertising through Television, Radio or Computer asking consumers to store said seller's contact information.

22. An electronic device with memory storage capabilities, said device provided by a first business and said electronic device having the contact information of at least one business other than said first business pre-programmed in the memory of said electronic device prior to being sold or provided to the end user of said electronic device, whenever said at least one other businesses having provided compensation for the placement of it's contact information in said electronic device.

23. The device of claim 22 wherein said one or more other businesses comprises at least five businesses, with each said business providing compensation for placement of its contact information to be preprogrammed in said electronic device.

24. The device of claim 22 wherein said electronic device is a cell phone.

25. The device of claim 22 wherein said electronic device is an electronic device with memory storage capabilities
